(19) United States
(12) Patent Application Publication
(10) Pub. No.: US 2017/0103651 A1
(43) Pub. Date: Apr. 13, 2017

(54) VEHICLE TURN-ON-RED INDICATOR SYSTEMS

(71) Applicant: Toyota Motor Engineering & Manufacturing North America, Inc., Erlanger, KY (US)

(72) Inventors: Christopher Lee Rovik, Northville, MI (US); Eric Randell Schmidt, Northville, MI (US)

(21) Appl. No.: 14/881,720

(22) Filed: Oct. 13, 2015

(51) Int. Cl. G08G 1/0967

(52) U.S. Cl. CPC G08G 1/0967

(57) ABSTRACT

A turn-on-red indicator system for a vehicle may include one or more processors, a right turn signal, a left turn signal, and a turn-on-red indicator. The one or more processors are configured to provide an affirmative turn-on-red signal and/or a negative turn-on-red signal to the turn-on-red indicator. The turn-on-red indicator is configured to provide an indicator to a driver of the vehicle that it is or is not, respectively, legally allowable to make a turn-on-red at a particular traffic light at a particular time.

### TECHNICAL FIELD

The present specification generally relates to an indicator system for a vehicle and, more specifically, a turn-on-red indicator system for providing real-time instructions to an operator of a vehicle stopped at a red traffic light as to whether or not restrictions are in place for making a turn-on-red at the present time.

### BACKGROUND

Traffic conditions and traffic lights that allow for a vehicle to turn on a red light (turn-on-red) at a traffic intersection are known. In such conditions, an operator of a vehicle typically approaches the red light, comes to a complete stop, and if no traffic is approaching the intersection, the operator makes either a right-hand turn or a left-hand turn depending on the traffic pattern at the intersection.

Traffic intersections with time and/or day limitations on making a “turn-on-red” are also known. Examples include restrictions during heavy traffic patterns, e.g. during rush hour, during school days, etc. Turn-on-red information signs which display one or more restrictions are typically located proximate to a traffic light such that a vehicle driver drives past the information sign while approaching the traffic light. However, the vehicle driver can miss or not notice the turn-on-red restriction(s) on a given turn-on-red information sign when approaching a red traffic light, also known simply as a “red light.” Therefore, it is known for a vehicle driver to be sitting at a red light and not be sure if a turn-on-red at the red light location is legally allowed at the present time. Stated differently, an operator can be sitting at a red light and desire to make a turn-on-red but not be sure if a turn-on-red is legally allowed at that time.

Accordingly, a need exists for an alternative turn-on-red indicator system that instructs a motor vehicle driver whether or not a turn-on-red at a given time for particular red light is allowed.

### SUMMARY

In one embodiment, a turn-on-red indicator system for a vehicle may include a vehicle one or more processors, a vehicle right turn signal, and a vehicle left turn signal. The vehicle right turn signal and the vehicle left turn signal are communicatively coupled with the one or more processors and the vehicle right turn signal and the vehicle left turn signal each have a light configured to be illuminated and display a first color. The turn-on-red indicator system also includes a turn-on-red indicator communicatively coupled to the one or more processors. The one or more processors are configured to provide at least one of an affirmative turn-on-red signal and a negative affirmative turn-on-red signal to the turn-on-red indicator. The turn-on-red indicator is configured to provide an operator of the vehicle at least one of a YES-turn-on-red indicator when provided with the affirmative turn-on-red signal from the processor and a NO-turn-on-red indicator when provided with the negative turn-on-red signal from the processor.

In another embodiment, a turn-on-red indicator system for a vehicle may include one or more processors, and a vehicle right turn signal and a vehicle left turn signal communicatively coupled with the one or more processors. The vehicle right turn signal and the vehicle left turn signal each have a light that is configured to be illuminated and display a first color. A turn-on-red indicator may also be included and be communicatively coupled with the processor. The one or more processors are configured to provide at least one of an affirmative turn-on-red signal and a negative affirmative turn-on-red signal to at least one of the processor and the turn-on-red indicator. The one or more processors are configured to receive data from at least one of a map database, a GPS satellite, a traffic light configured to provide data, a turn-on-red information sign configured to provide data, an environment information data module and a weather sensor. The turn-on-red indicator is configured to provide an operator of the vehicle at least one of a YES-turn-on-red indicator when provided with the affirmative turn-on-red signal from the processor and a NO-turn-on-red indicator when provided with the negative turn-on-red signal from the processor. In addition, the processor is configured to provide the YES-turn-on-red indicator and the NO-turn-on-red indicator only when one of the vehicle right turn signal and the vehicle left turn signal is activated.

These and additional features provided by the examples, aspects, etc. described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative examples, aspects, etc. can be understood when read in conjunction with the following drawings, where like structure is indicated with like reference numerals and in which:

FIG. 1 depicts a schematic perspective view of a vehicle at a traffic light with a driver of the vehicle desiring to make a turn at a red traffic light;

FIG. 2 depicts a schematic diagram of a turn-on-red indicator system according to one or more embodiments described herein;

FIG. 3 depicts a schematic diagram of a traffic light module that can be part of the traffic light shown in FIG. 2 according to one or more embodiments described herein;

FIG. 4 depicts a schematic diagram of the ECU shown in FIG. 2 according to one or more embodiments described herein;

FIG. 5 depicts a schematic diagram of a process for using a turn-on-red indicator system according to one or more embodiments described herein; and

FIG. 6 depicts a schematic perspective view of a dashboard area of a vehicle with a turn-on-red indicator according to one or more embodiments described herein.

### DETAILED DESCRIPTION

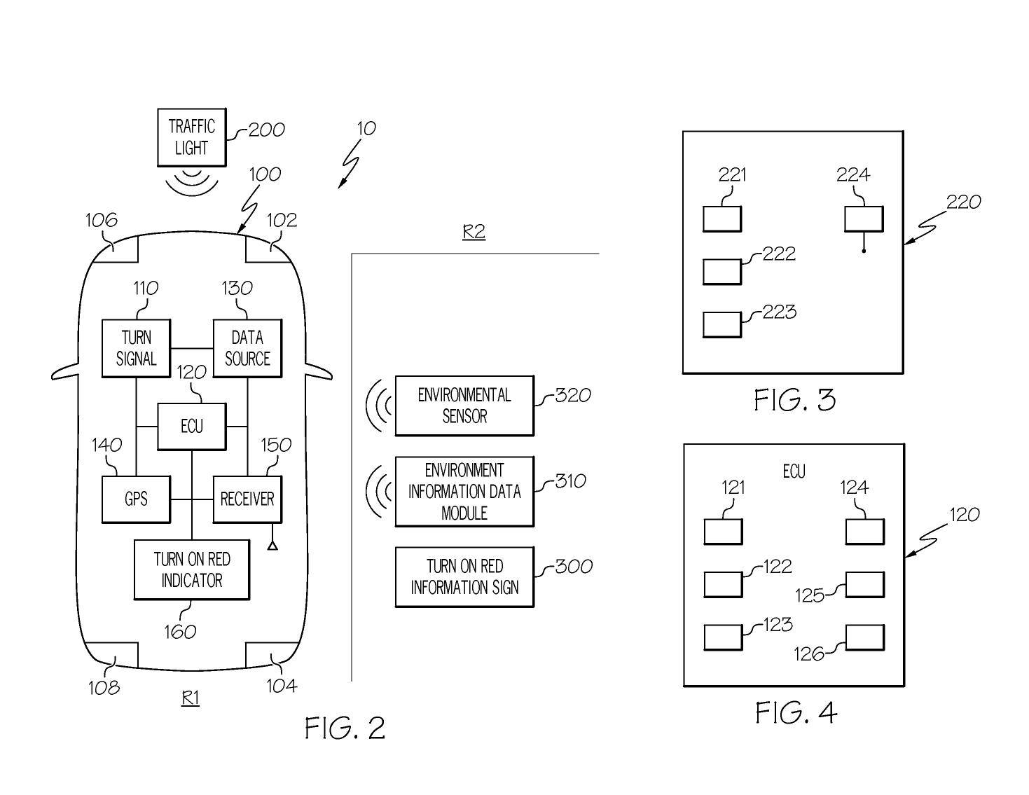

FIG. 2 generally depicts one embodiment of a turn-on-red indicator system for providing instructions to an operator or driver of a vehicle as to whether or not it is legally allowable to make a turn at a particular red traffic light (turn-on-red) when the vehicle is stopped at the traffic light. The system includes a motor vehicle with a turn-on-red indicator system. The turn-on-red indicator system includes vehicle turn signals and an electronic control unit (ECU). The turn-on-red indicator system can also include a GPS system, a receiver, an optional turn-on-red data module and a turn-on-red indicator. The ECU is configured to receive data from an external data source, for example a traffic light, a turn-on-red information sign, an environment information data module, an environmental sensor, and the like. The ECU processes data and determines if at the time that the vehicle is at a particular traffic intersection with a traffic light whether or not the driver of the vehicle is legally allowed to make a turn-on-red. In the event that the ECU determines a turn-on-red is allowed, the ECU is configured to instruct the turn-on-red indicator to provide an affirmative turn-on-red indicator to the driver. In the alternative, if the ECU determines that it is not allowed to make a turn-on-red at the particular traffic light where the vehicle is located at the present time, the ECU is configured to instruct the turn-on-red indicator to provide a negative turn-on-red indicator to the driver. It should be appreciated that the turn-on-red system disclosed herein applies to a vehicle making a right hand turn at a red traffic light (red light) and/or to a vehicle making a left hand turn at a red light where a traffic pattern, e.g. a one-way street, allows such a turn.

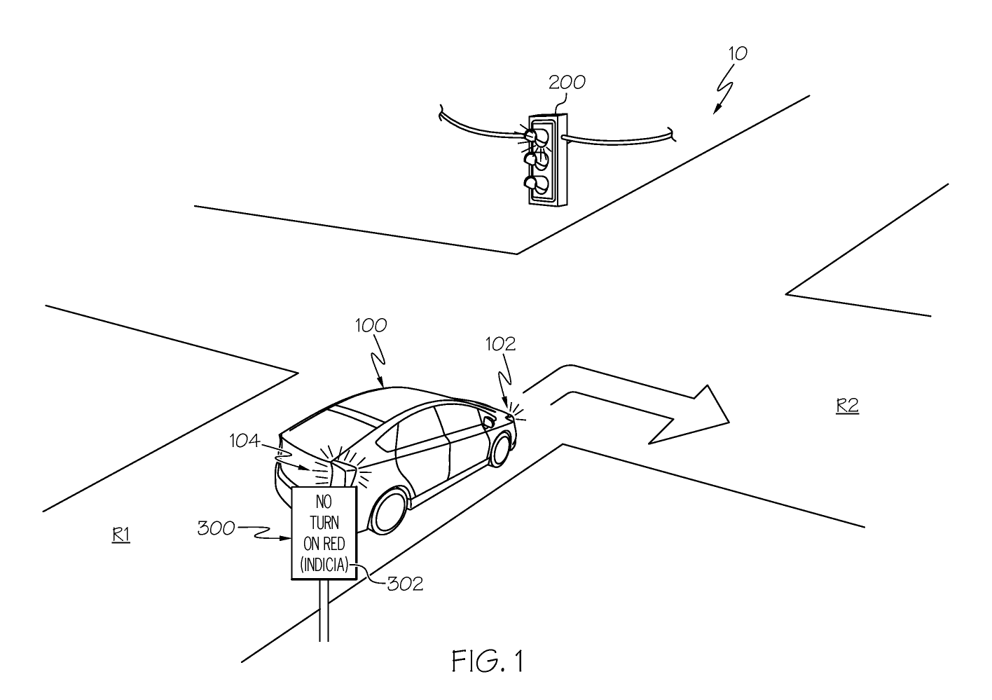

Referring now to FIG. 1, a vehicle 100 with a turn-on-red indicator system is shown generally at reference numeral 10. The vehicle 100 is at a traffic intersection where road R1 intersects road R2 (intersection R1-R2). The intersection R1-R2 has a traffic light 200 and a turn-on-red information sign 300. Also illustrated in the figure is the vehicle 100, i.e. a driver within the vehicle 100, desiring to make a right-hand turn as shown by the arrow and turn signal lights 102 and 104 activated. Indicia 302 on the turn-on-red information sign 300 can provide information or restrictions as to when it is not allowed to make a turn-on-red at the traffic light 200. In the alternative, the indicia 302 can provide information as to when it is allowed to make a turn-on-red at the traffic light 200.

Information provided by the indicia 302 can include a certain range of time or times in a given day, certain days of the week, certain times of a calendar year, and the like. For example and for illustrative purposes only, the indicia 302 can state “On School Days 7:00-9:00 AM and 2:30-4:30 PM”, “6:00-9:00 AM and 4:00-6:00 PM”, etc. As such, when a driver of the vehicle 100 approaches the traffic light 200, the turn-on-red information sign 300 with the indicia 302 instructs the driver whether or not it is legally allowed to make a turn-on-red at the intersection R1-R2 when the vehicle 100 is present. However, in some instances, the driver can “miss” the turn-on-red information sign 300, and/or not notice the indicia 302. In such instances, the driver can be sitting at the traffic light 200, when it is red, and not be sure whether or not he/she is legally allowed to make a turn from the road R1 onto the road R2 at the present time.

Referring now to FIG. 2, a turn-on-red indicator system 10 is configured to instruct the driver whether or not the vehicle 100 is legally allowed to make a turn-on-red at the traffic light 200. The vehicle 100 includes a pair of front turn signal lights 102, 106 and a pair of rear turn signal lights 104, 108. The driver of the vehicle 100 activates the turn signal lights 102,106 or 104,108 to indicate a desire to make a right-hand turn or a left-hand turn, respectively. The driver can activate the turn signal lights using a turn signal 110 within the vehicle 100, such a turn signal 110 typically including a lever that the driver manipulates when desiring to make a turn.

The turn-on-red indicator system 10 also includes an electronic control unit (ECU) 120 that is communicatively coupled with the turn signal 110. An optional data source 130 and a navigation system (GPS) 140 are also communicatively coupled with the ECU 120, as is a receiver 150, e.g. an antenna, which is configured to transmit data to and receive data from an outside source. The turn-on-red indicator system 10 includes a turn-on-red indicator 160 which is configured to provide an indicator or indication to the driver of the vehicle 100 that it is legally allowable to make a turn-on-red at the traffic light 200 or it is not legally allowable to make a turn-on-red at the traffic light 200 at the present time.

The traffic light 200 may be configured to transmit data on any restrictions for turning on red at the intersection of road R1 and road R2 (R1-R2). Such restrictions can be in the form of a restricted range of times, restricted days of the week, and the like. In the alternative, the traffic light 200 can be configured to transmit data to the vehicle 100 which simply provides a simple “YES” or “NO” as to whether or not it is allowed to make a turn-on-red at this particular intersection.

Referring to FIG. 3, a traffic light data module 220 can be part of the traffic light 200. The traffic light data module 220 can have one or more processors 221, one or memory modules 222, a digital clock 223, and a transceiver/receiver 224. The one or more memory modules 221 can be configured as RAM, ROM, flash memories, hard drives, and/or any device capable of storing machine readable instructions such that the machine readable instructions can be accessed by the one or more processors 221. In addition, the one or memory modules 222 can contain turn-on-red restriction data on the traffic light 200 which can accessed by the one or more processors 221 and transmitted to the vehicle 100 using the transceiver/receiver 224. For example and for illustrative purposes only, the turn-on-red restriction data can be in the form of “No Turn-On-Red During School Days Between 7:00-9:00 AM and 2:30-4:30 PM”, “No Turn-On-Red During Weekdays Between 6:00-9:00 AM and 4:00-6:00 PM,” and the like. In the alternative, the one or more processors 221 in combination with the digital clock 223 can determine if a turn-on-red is allowed at the traffic light 200 at the present time and then afford for a simple “YES” or “NO” to be transmitted to the vehicle 100 via transceiver/receiver 224. It should be appreciated that new, revised and/or updated turn-on-red restriction data can be transmitted to the traffic light data module, either wired or wirelessly, received via the transceiver/receiver 224 and stored in the one or more memory modules 222. In this manner, up-to-date turn-on-red restriction data can be configured to transmit data on any restrictions for turning on red at the intersection of road R1 and road R2 (R1-R2).

An environment information data module 310, which may or may not be part of or attached to the turn-on-red information sign 300, can be included and be configured to transmit data to the vehicle 100. The data that is transmitted from the environment information data module 310 can be in the form of restrictions on making a turn-on-red at the particular intersection R1-R2, or in the alternative, a simple YES or NO as to whether or not it is allowed to make a turn-on-red at the intersection.

In some instances, an environmental sensor 320 can be included and be configured to transmit data to the vehicle 100. For example and for illustrative purposes only, the environmental sensor 320 can be a weather sensor that can detect whether or not it is raining at the intersection R1-R2, whether it is snowing, whether it is foggy, whether it is daytime, and/or whether it is nighttime. The environmental sensor is also configured to transmit such environment data to the vehicle 100 and/or ECU 120. In the alternative, the environmental sensor 320 can provide data to the vehicle 100 and/or ECU 120 in the form of a simple YES or NO as to whether or not it is allowed to make a turn-on-red at the R1-R2 intersection at the present time.

The ECU 120 and/or the one or more processors 121 are configured to process data provided by the traffic light 200, environment information data module 310 and/or environmental sensor 320 and determine whether or not a turn-on-red is allowed at the present location and the present time.

Referring now to FIG. 4, a schematic diagram of the ECU 120 includes one or more processors 121, one or more memory modules 122, and other components 123-126. Each of the one or more processors 121 may be a controller, an integrated circuit, a microchip or any other computing device. The one or more processors 121 can be coupled to a communication path that provides signal interconnectivity between various modules of the ECU 120. In addition, the ECU 120 can be coupled to a communication path that provides signal interconnectivity between the turn signal 110, optional data source 130, navigation system 140, receiver 150 and turn-on-red indicator 160 (FIG. 2). The communication path can be formed from any medium that is capable of transmitting a signal such as, for example, conductive wires, conductive traces, optical waveguides, or the like. Moreover, the communication path can be formed from a combination of mediums capable of transmitting signals. For example, the communication path can include a combination of conductive traces, conductive wires, connectors, and buses that cooperate to permit the transmission of electrical data signals to components such as processors, memories, sensors, input devices, output devices, and communication devices. Accordingly, the communication path can include a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

Each of the one or more memory modules 122 may be configured as RAM, ROM, flash memories, hard drives, and/or any device capable of storing machine readable instructions such that the machine readable instructions can be accessed by the one or more processors 121. The machine readable instructions can comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the one or more memory modules 122. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

The ECU 120 can determine whether or not a right turn signal or left turn signal has been activated for the motor vehicle 100, which in turn can be a trigger for initiating the turn-on-red indicator system 10.

Referring also to FIG. 2, the optional data source 130 may or may not be part of the navigation system 140. The navigation system 140 is depicted as coupled to the vehicle 100, however the navigation system 140 can be in isolation. Also, the navigation system 140 is referred to herein as a vehicle navigation system, however it should be understood that in some embodiments the navigation system 140 may not be associated with a vehicle, such as hand-held global positioning system (GPS) units that is communicatively coupled with the ECU 120. In addition, the optional data source 130 can have a listing of locations (e.g., latitude and longitude) where turn-on-red restrictions are known to be present. The optional data source 130 can also have a listing of the restrictions that apply for each location. In this manner, data from the optional data source 130 can be read by the one or more processors 121 and paired with a GPS location to afford the ECU 120 to determine whether or not a turn-on-red is allowed at a given traffic light at the time the vehicle 100 is present.

The receiver 150 may be configured to receive signals from global positioning system satellites. Specifically, the receiver 150 can include one or more conductive elements acting as an antenna that interact with electromagnetic signals transmitted by global positioning system satellites. The received signal can be transformed into a data signal indicative of the location (e.g., latitude and longitude) of the receiver 150 or an object positioned near the receiver 150, by the one or more processors 121. The received signal can be transformed to correspond to the location (e.g., latitude and longitude) of the receiver 150.

The receiver 150 can also be any device capable of transmitting and/or receiving data via a wireless network. Accordingly, the receiver 150 can include a communication transceiver for sending and/or receiving data according to any wireless communication standard. For example, the receiver 150 may include a chipset (e.g., antenna, processors, machine readable instructions, etc.) to communicate over wireless computer networks such as, for example, wireless fidelity (Wi-Fi), WiMax, Bluetooth, IrDA, Wireless USB, Z-Wave, ZigBee, or the like. As such, the receiver 150 is configured to transmit data and/or receive data from the traffic light 200, environment information data module 310 and/or environmental sensor 320.

The turn-on-red indicator 160 may be configured to receive a signal from the one or more processors 121 and as a function of the received signal provide an indicator to the driver of the vehicle 100 as to whether or not it is legally allowed (OK) to make a turn-on-red at the traffic light 200 at the present time. The indicator can be in the form of an affirmative indicator with respect to making a turn-on-red at the traffic light 200 and/or a negative indicator with respect to making a turn-on-red at the traffic light 200. The affirmative and/or negative indicator can be in the form of a visual indicator to the driver, an audible indicator to the driver, a tactile indicator to the driver or a combination thereof. In some instances, the turn-on-red indicator 160, and thus the turn-on-red indicator system 10, only provides an affirmative indicator to the driver when it is OK to make a turn-on-red at a given light and the present time, i.e. the system 10 does not provide a negative turn-on-red indicator. In other instances, the turn-on-red indicator 160 only provides a negative indicator to the driver when it is not OK to make a turn-on-red at a given light and the present time, i.e. the system 10 does not provide a positive turn-on-red indicator. In still other instances, the turn-on-red indicator 160 provides an affirmative indicator to the driver when it is OK to make a turn-on-red at a given light and the present time, and provides a negative indicator to the driver when it is not OK to make a turn-on-red at a given light and the present time.

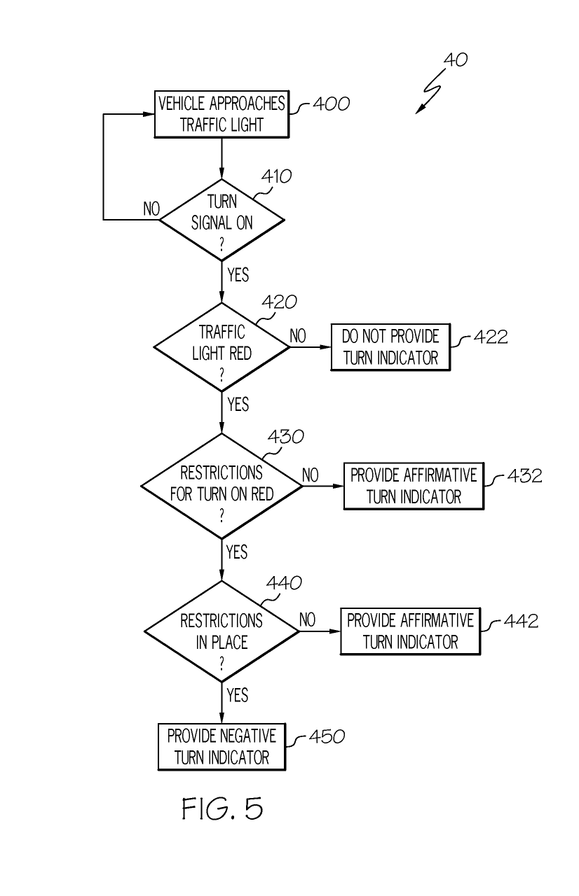

Referring now to FIG. 5, an illustrative process using of the turn-on-red indicator system 10 is shown generally at reference numeral 40. In particular, the vehicle 100 approaches the traffic light 200 at step 400 and the ECU 120 determines whether or not the turn signal 110 has been activated at step 410. In the event that the turn signal has not been activated as indicated by the ‘NO’ shown in the figure, the system simply returns to step 400 in which the system is not activated. In the event that the turn signal is activated as indicated by the ‘YES’ shown in FIG. 5, the system proceeds to determine if the traffic light is red at step 420. If the traffic light is not red, e.g. the traffic light is green, then a turn-on-red indicator is not provided as shown at step 422.

In the alternative, if the traffic light 200 is red at step 420, the system proceeds to determine whether or not restrictions are in place for the turn-on-red at the traffic light 200 at step 430. In the event that no restrictions or limitations are present at the traffic light 200, e.g. there is no turn-on-red information sign 300, then the system 10 can provide an affirmative turn-on-red indicator at step 432. In the alternative, if restrictions or limitations for a turn-on-red are provided, e.g. the turn-on-red information sign 300 is present, the system proceeds to step 440 in which it is determined whether the restrictions are in place at the particular time that the vehicle 100 is at the intersection R1-R2. If the restrictions are not in place, or in the alternative if an exception to a restriction is in place, then the system provides an affirmative turn-on-red indication to the driver at step 442. However, if the restrictions are in place, the system provides a negative turn-on-red indicator 450. It is appreciated that the system can provide an affirmative turn-on-red indicator or a negative turn-on-red indicator or both. Stated differently, the system can include only providing an affirmative turn-on-red indicator to a driver when no restrictions are present at the particular traffic light 200, or in the alternative, the system can only provide a negative turn indicator to a driver when restrictions are place. In the alternative, the system 10 can provide an affirmative turn indicator when no restrictions are in place and a negative turn indicator when restrictions are in place.

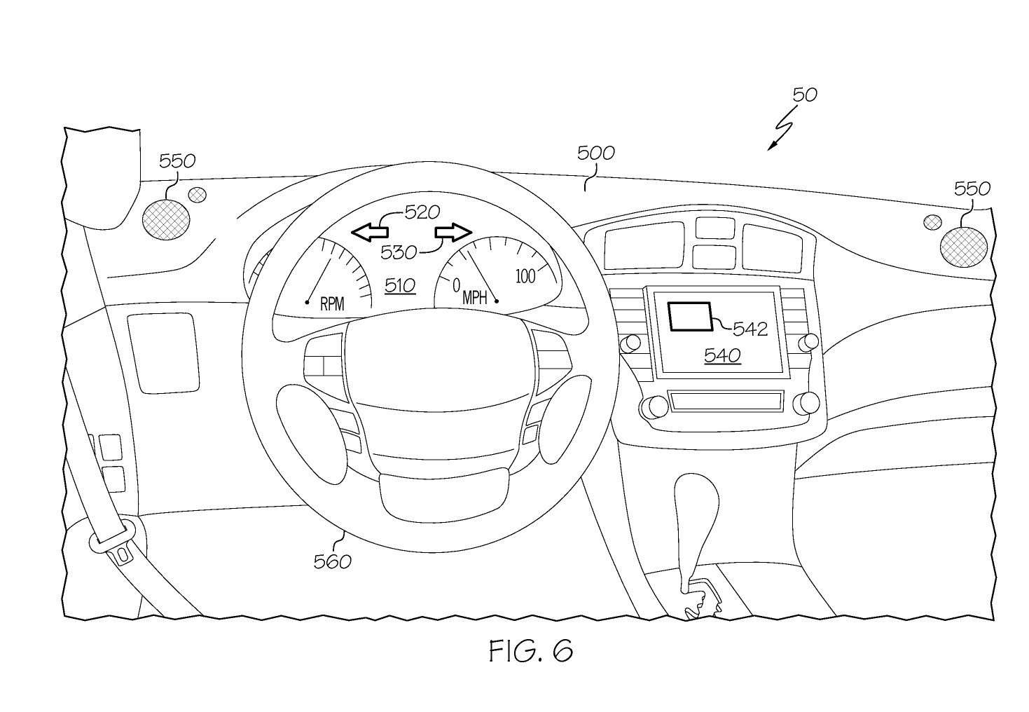

Referring now to FIG. 6, a schematic illustration of a dashboard area 50 with three different turn-on-red indicators is shown. The dashboard area 50 includes a dashboard 500 with an instrument panel 510. The instrument panel 510 includes a left turn signal indicator 520 and a right turn signal indicator 530. The dashboard 500 also includes a center console with a display 540, one or more audio speakers 550, and a vehicle steering wheel 560. It is appreciated that the left turn signal indicator 520 and the right turn signal indicator 530 blink on and off when a given turn signal is activated as is known to those skilled in the art. In addition, it is also appreciated that the left turn signal indicator 520 and right turn signal indicator 530 illuminate or blink a first color during operation of the respective turn signal.

In the event that an affirmative turn-on-red signal is provided by the processor, the left turn signal indicator 520 and/or right turn signal indicator 530 can be illuminated and display a second color. For example and for illustrative purposes only, the left turn signal indicator 520 and the right turn signal indicator 530 can be illuminated with a yellow color (first color) during normal operation of the vehicle and then illuminated with a green color (second color) when the vehicle is at a turn signal and an affirmative turn-on-red signal is provided by the processor. In the alternative, or in addition, the left turn signal indicator 520 and right turn signal indicator 530 can be illuminated to display a third color when a negative turn-on-red signal is provided by the processor. For example and for illustrative purposes only, the left turn signal indicator 520 and right turn signal indicator 530 can be illuminated to display a red color (third color) when the negative turn-on-red signal is provided by the processor.

The central display 540 may also be used to provide an affirmative turn-on-red signal and/or a negative turn-on-red signal. For example and for illustrative purposes only, an indicator portion 542 of the display 540 can be used to display a first color for an affirmative turn-on-red signal from the processor and a second color for a negative turn-on-red signal from the processor. For example and for illustrative purposes only, the indicator portion 542 can display a green color when the affirmative turn-on-red signal is received from the processor and/or a red color when a negative turn-on-red signal is received from the processor. The indicator portion 542 can also provide a text message, e.g. a “YES” or “NO” when the ECU determines it is allowed or not allowed, respectively, to make a turn-on-red at the given traffic light at the present time.

The turn-on-red indicator system can also provide an audible affirmative turn-on-red signal and/or a negative turn-on-red signal, e.g. using one or more speakers 550. Such an audible signal can be in the form of a tone, ring, one or more audible words, and the like.

The turn-on-red indicator system can also include a tactile signal when an affirmative turn-on-red signal and/or a negative turn-on-red signal is provided from the processor. For example and for illustrative purposes only, the vehicle steering wheel 560 can be configured to vibrate within the hands of a driver of the vehicle when an affirmative turn-on-red signal and/or a negative turn-on-red signal is provided by the processor.

The above-described turn-on-red indicator systems provide instructions to a driver of a vehicle as to whether it is legally allowable to make a turn-on-red at a given traffic light at the present time. As such, if the vehicle driver misses or does not notice turn-on-red restriction(s) on a turn-on-red information sign when approaching a red traffic light, the driver can be informed as to whether or not making a turn-on-red at the traffic light and at the present time is allowed.

While particular aspects, examples, etc. have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims, and all equivalents thereof, cover all such changes and modifications that are within the scope of the claimed subject matter.

What is claimed is:

1. A turn-on-red indicator system for a vehicle comprising:
one or more processors;
a vehicle right turn signal and a vehicle left turn signal communicatively coupled with said processor, said vehicle right turn signal and said vehicle left turn signal each having a light configured to be illuminated and display a first color; and
a turn-on-red indicator communicatively coupled to said processor;
said one or more processors configured to provide at least one of an affirmative turn-on-red signal and a negative turn-on-red signal to said turn-on-red indicator;
said turn-on-red indicator configured to provide a driver of the vehicle at least one of an affirmative turn-on-red indicator when provided with said affirmative turn-on-red signal from said processor and a negative turn-on-red indicator when provided with said negative turn-on-red signal from said one or more processors.

2. The turn-on-red indicator system of claim 1, wherein said one or more processors are configured to receive data from at least one of a map database, a GPS satellite, a traffic light configured to provide data to said one or more processors, a turn-on-red information sign configured to provide data to said one or more processors, an environment information data module configured to provide data to said one or more processors and a weather sensor configured to provide data to said one or more processors.

3. The turn-on-red indicator system of claim 2, wherein said one or more processors are configured to provide said at least one of said affirmative turn-on-red indicator and said negative turn-on-red indicator only when one of said vehicle right turn signal and said vehicle left turn signal is activated.

4. The turn-on-red indicator system of claim 3, wherein said at least one of said affirmative turn-on-red indicator and said negative turn-on-red indicator is at least one of a visual indicator, an audible indicator and a tactile indicator.

5. The turn-on-red indicator system of claim 4, wherein said at least one of said affirmative turn-on-red indicator and said negative turn-on-red indicator is a visual indicator and said visual indicator is said light of said vehicle right turn signal and said vehicle left turn signal being illuminated and displaying a second color.

6. The turn-on-red indicator system of claim 4, further comprising an affirmative turn-on-red indicator and a negative turn-on-red indicator.

7. The turn-on-red indicator system of claim 6, wherein said affirmative turn-on-red indicator and said negative turn-on-red indicator is a visual indicator and said visual indicator for said affirmative turn-on-red indicator is said light of said vehicle right turn signal and said vehicle left turn signal being illuminated and displaying a second color and said visual indicator for said negative turn-on-red indicator is said light of said vehicle right turn signal and said vehicle left turn signal being illuminated and displaying a third color.

8. The turn-on-red indicator system of claim 4, wherein said at least one of said affirmative turn-on-red indicator and said negative turn-on-red indicator is a tactile indicator and said tactile indicator is a vibration of a vehicle steering wheel.

9. The turn-on-red indicator system of claim 4, wherein said at least one of said affirmative turn-on-red indicator and said negative turn-on-red indicator is an audible indicator and said audible indicator is an audible signal in the form of at least one of a tone, a ring and one or more audible words.

10. A vehicle with a turn-on-red indicator system, said vehicle comprising:
one or more a processors;
a vehicle right turn signal and a vehicle left turn signal communicatively coupled with said one or more processors, said vehicle right turn signal and said vehicle left turn signal each having a light configured to be illuminated to display a first color; and
a turn-on-red indicator communicatively coupled to said one or more processors;
said one or more processors configured to provide at least one of an affirmative turn-on-red signal and a negative turn-on-red signal to said turn-on-red indicator when one of said vehicle right turn signal and said vehicle left signal is activated;
said turn-on-red indicator configured to provide a driver of the vehicle at least one of an affirmative turn-on-red indicator when provided with said affirmative turn-on-red signal from said one or more processors and a negative turn-on-red indicator when provided with said negative turn-on-red signal from said one or more processors.

11. The vehicle of claim 10, wherein said one or more processors are configured to receive data from at least one of a map database, a GPS satellite, a traffic light configured to provide data to said one or more processors, a turn-on-red information sign configured to provide data to said one or more processors, an environment information data module and a weather sensor.

12. The vehicle of claim 11, wherein said at least one of said affirmative turn-on-red indicator and said negative turn-on-red indicator is at least one of a visual indicator, an audible indicator and a tactile indicator.

13. The vehicle of claim 12, wherein said at least one of said affirmative turn-on-red indicator and said negative turn-on-red indicator is a visual indicator and said visual indicator is said light of said vehicle right turn signal and said vehicle left turn signal being illuminated and displaying a second color.

14. The vehicle of claim 12, wherein said at least one of said affirmative turn-on-red indicator and said negative turn-on-red indicator is a tactile indicator and said tactile indicator is a vibration of a vehicle steering wheel.

15. A process for providing turn-on-red information to a driver of a vehicle at a traffic light, the process comprising:
providing a vehicle with a turn-on-red indicator system, the turn-on-red indicator system having:
one or more processors;
a vehicle right turn signal and a vehicle left turn signal communicatively coupled with said processor, the vehicle right turn signal and the vehicle left turn signal each having a light configured to be illuminated and display a first color; and
a turn-on-red indicator communicatively coupled to the one ore processors;
the one or more processors configured to provide at least one of an affirmative turn-on-red signal and a negative turn-on-red signal to the turn-on-red indicator;
the turn-on-red indicator configured to provide a driver of the vehicle at least one of an affirmative turn-on-red indicator when provided with the affirmative turn-on-red signal from the one or more processors and a negative turn-on-red indicator when provided with the negative turn-on-red signal from the one or more processors;
the driver driving the vehicle up to red traffic light;
activating the vehicle right turn signal or the vehicle left turn signal;
the one or more processors providing the turn-on-red indicator with the affirmative turn-on-red signal or the negative turn-on-red signal;
the turn-on-red indicator providing the driver of the vehicle with the affirmative turn-on-red indicator when the affirmative turn-on-red signal is provided to the turn-on-red indicator and the negative turn-on-red indicator when the negative turn-on-red signal is provided to the turn-on-red indicator.

16. The process of claim 15, further including providing data to the one or more processors, data provided from at least one of a map database, a GPS satellite, a traffic light configured to provide data to the one or more processors, a turn-on-red information sign configured to provide data to the one or more processors, an environment information data module configured to provide data to the one or more processors and a weather sensor configured to provide data to the one or more processors.

17. The process of claim 16, wherein the at least one of the affirmative turn-on-red indicator and the negative turn-on-red indicator is at least one of a visual indicator, an audible indicator and a tactile indicator.

18. The process of claim 17, wherein the at least one of the affirmative turn-on-red indicator and the negative turn-on-red indicator is a visual indicator.

19. The process of claim 18, wherein the one or more processors provide the turn-on-red indicator an affirmative turn-on-red signal and the activated vehicle right turn signal or vehicle left turn signal is illuminated and displays a second color.

20. The process of claim 19, wherein the one or more processors provide the turn-on-red indicator a negative turn-on-red signal and the activated vehicle right turn signal or vehicle left turn signal is illuminated and displays a third color.
